(19) United States
(12) Patent Application Publication
(10) Pub. No.: US 2018/0245183 A1
(43) Pub. Date: Aug. 30, 2018

(54) COPPER ALLOY FOR ELECTRONIC AND ELECTRIC DEVICE, COMPONENT FOR ELECTRONIC AND ELECTRIC DEVICE, TERMINAL, AND BUS BAR

(71) Applicants: MITSUBISHI MATERIALS CORPORATION, Tokyo (JP); Mitsubishi Shindoh Co., Ltd., Tokyo (JP)

(72) Inventors: Kazunari MAKI, Saitama-shi (JP); Yuki ITO, Ageo-shi (JP); Takanori KOBAYASHI, Aizuwakamatsu-shi (JP)

(73) Assignees: MITSUBISHI MATERIALS CORPORATION, Tokyo (JP); Mitsubishi Shindoh Co., Ltd., Tokyo (JP)

(21) Appl. No.: 15/758,265

(22) PCT Filed: Sep. 8, 2016
(86) PCT No.: PCT/JP2016/076386

§ 371 Date: Mar. 7, 2018

(30) Foreign Application Priority Data
Sep. 9, 2015 (JP) 2015-177742

(51) Int. Cl. C22C 9/02; C22C 9/00; C22F 1/08; H01B 1/02

(52) U.S. Cl. CPC C22C 9/02; H01B 1/026; C22F 1/08; C22C 9/00

(57) ABSTRACT

Provided is a copper alloy for an electronic and electric device, including: Mg in a range of 0.5 mass % or more and 3.0 mass % or less; and a Cu balance including inevitable impurities, in which, a graph, in which a vertical axis is dσₜ/dεₜ and a horizontal axis is a true strain εₜ, dσₜ/dεₜ being defined by a true stress σₜ and the true strain εₜ, obtained in a tensile test of the copper alloy, has a strained region that has a positive slope of dσₜ/dεₜ.

### CROSS-REFERENCE TO RELATED PATENT APPLICATIONS

This application is a U.S. National Phase application under 35 U.S.C. § 371 of International Patent Application No. PCT/JP2016/076386 filed on Sep. 8, 2016 and claims the benefit of Japanese Patent Application No. 2015-177742, filed on Sep. 9, 2015, all of which are incorporated herein by reference in their entireties. The International Application was published in Japanese on Mar. 16, 2017 as International Publication No. WO/2017/043558 under PCT Article 21(2).

### FIELD OF THE INVENTION

The present invention relates to a copper alloy for an electronic and electric device suitable for a component for an electronic and electric device such as a terminal such as a connector or a press fit, a relay, a lead frame, or a bus bar, and a component for an electronic and electric device, a terminal, and a bus bar made of this copper alloy for an electronic and electric device.

### BACKGROUND OF THE INVENTION

In the related art, copper or a copper alloy having high conductivity is used for a component for an electronic and electric device such as a terminal such as a connector or a press fit, a relay, a lead frame, or a bus bar.

These components for an electronic and electric device are normally manufactured by forming a predetermined shape by performing a punching process on a rolled sheet having a thickness of approximately 0.05 to 3.0 mm, and performing a bending process with respect to at least a part thereof. It is required that materials configuring such components for an electronic and electric device have excellent bendability and high strength.

Here, Japanese Unexamined Patent Application, First Publication No. 2011-241412, for example, has proposed a Cu—Mg alloy as a material used in the component for an electronic and electric device such as a terminal such as a connector or a press fit, a relay, a lead frame, or a bus bar. This Cu—Mg alloy has an excellent balance between strength, conductivity, and bendability, and thus is particularly suitable as a raw material of the component for an electronic and electric device.

### Technical Problem

Meanwhile, recently, a large current and a large voltage have been loaded with respect to a component for an electronic and electric device, and thus, a comparatively thick copper alloy material having a thickness of 0.5 mm, 1 mm, 2 mm, or 3 mm has been provided as a raw material of the component for an electronic and electric device. Accordingly, it is necessary that the copper alloy for an electronic and electric device has excellent bendability in a case of various thicknesses.

The present invention is made in consideration of these circumstances and an object thereof is to provide a copper alloy for an electronic and electric device, a component for an electronic and electric device, a terminal, and a bus bar having particularly excellent bendability and high 0.2% yield strength.

### SUMMARY OF THE INVENTION

### Solution to Problem

As a result of intensive studies, the present inventors have gained the following knowledge. In a case of performing a bending process with respect to a copper alloy material having a comparatively small thickness, the bending process is performed in a small die. Accordingly, a region to be bent is narrow and deformation locally occurs. Thus, bendability is affected by local elongation. On the other hand, in a case of performing the bending process with respect to a copper alloy material having a comparatively great thickness, the bending process is performed in a large die. Accordingly, a region to be bent is wide. Thus, bendability is affected by uniform elongation, rather than local elongation.

Here, in a case where a tensile test is performed for a typical copper alloy material until the fracture of the material, a value of dσₜ/dεₜ (σₜ: true stress, εₜ: true strain) corresponding to a work-hardening rate steadily decreases with an increase in strain, in a region of elastic deformation and plastic deformation. However, as a result of intensive studies, the present inventors have found that the dσₜ/dεₜ increases after the plastic deformation, by performing specific heat treatment with respect to the copper alloy material.

In addition, the inventors have found that, in a case where the dσₜ/dεₜ increases after the plastic deformation, uniform elongation is improved, and thus, even in a case where the thickness of the copper alloy material is comparatively great, bendability is improved.

The present invention is made based on the knowledge described above, and a copper alloy for an electronic and electric device according to one aspect of the present invention (hereinafter, referred to as a “copper alloy for an electronic and electric device of the present invention”) includes Mg in a range of 0.5 mass % or more and 3.0 mass % or less; and a Cu balance including inevitable impurities, and a graph, in which a vertical axis is dσₜ/dεₜ and a horizontal axis is a true strain εₜ, dσₜ/dεₜ being defined by a true stress σₜ and the true strain εₜ, obtained in a tensile test of the copper alloy, has a strained region that has a positive slope of dσₜ/dεₜ.

According to the copper alloy for an electronic and electric device having the configuration described above, a graph, in which a vertical axis is dσₜ/dεₜ and a horizontal axis is a true strain εₜ, dσₜ/dεₜ being defined by a true stress σₜ and the true strain εₜ, obtained in a tensile test of the copper alloy, has a strained region that has a positive slope of dσₜ/dεₜ, the dσₜ/dεₜ increases, after plastic deformation, and thus, uniform elongation is improved. Therefore, it is possible to improve bendability, even in a case where a thickness of the copper alloy material is comparatively great.

Since 0.5 mass % to 3.0 mass % of Mg is included, excellent heat resistance is obtained and a strained region having a positive slope of the dσₜ/dεₜ is obtained. Thus, even in a case where specific heat treatment is performed, a great decrease in 0.2% yield strength can be prevented and high 0.2% yield strength can be ensured.

Here, in the copper alloy for an electronic and electric device of the present invention, it is preferable that 0.2% yield strength after finish heat treatment is 400 MPa or more.

In this case, since the 0.2% yield strength after the finish heat treatment is 400 MPa or more, the copper alloy for an electronic and electric device is particularly suitable as the material of the component for an electronic and electric device.

In the copper alloy for an electronic and electric device of the present invention, it is preferable that the rise amount of dσₜ/dεₜ is 30 MPa or more.

In this case, since the rise amount of dσₜ/dεₜ is 30 MPa or more, uniform elongation is reliably improved and particularly excellent bendability can be obtained.

The copper alloy for an electronic and electric device of the present invention may further include Pin a range of 0.001 mass % or more and 0.1 mass % or less.

In this case, since 0.001 mass % or more of P is included, castability can be improved. Since the content of P is equal to or less than 0.1 mass %, a great decrease in conductivity can be prevented, even in a case where P is added.

The copper alloy for an electronic and electric device of the present invention may further include S in a range of 0.1 mass % or more and 2.0 mass % or less.

In this case, since 0.1 mass % or more of Sn is included, heat resistance can be further improved, and a decrease in 0.2% yield strength after heat treatment can be reliably prevented. Since the content of Sn is equal to or less than 2.0 mass %, a great decrease in conductivity can be prevented, even in a case where Sn is added.

A component for an electronic and electric device according to another aspect of the present invention (hereinafter, referred to as a “component for an electronic and electric device of the present invention”) is made of the copper alloy for an electronic and electric device described above. The component for an electronic and electric device includes a terminal such as a connector or a press fit, a relay, a lead frame, or a bus bar.

The component for an electronic and electric device having this configuration is manufactured by using the copper alloy for an electronic and electric device described above, thus, a bending process is satisfactorily performed and excellent reliability is obtained.

A terminal according to still another aspect of the present invention (hereinafter, referred to as a “terminal of the present invention”) is made of the copper alloy for an electronic and electric device described above.

A bus bar according to still another aspect of the present invention (hereinafter, referred to as a “bus bar of the present invention”) is made of the copper alloy for an electronic and electric device described above.

The terminal and the bus bar of the present invention are manufactured by using the copper alloy for an electronic and electric device described above, thus, a bending process is satisfactorily performed and excellent reliability is obtained.

### Advantageous Effects of Invention

According to the present invention, it is possible to provide the copper alloy for an electronic and electric device, the component for an electronic and electric device, the terminal, and the bus bar having particularly excellent bendability and high 0.2% yield strength.

### BRIEF DESCRIPTION OF THE DRAWINGS

FIG. 1 is a graph showing a relationship between dσₜ/dεₜ (work-hardening rate) and εₜ (true strain) of a copper alloy for an electronic and electric device of the embodiment.

FIG. 2 is a flowchart of a manufacturing method of the copper alloy for an electronic and electric device of the embodiment.

### DETAILED DESCRIPTION OF THE INVENTION

Hereinafter, a copper alloy for an electronic and electric device according to one embodiment of the present invention will be described.

The copper alloy for an electronic and electric device of the embodiment has a composition including Mg in a range of 0.5 mass % or more and 3.0 mass % or less; and a Cu balance including inevitable impurities.

The copper alloy for an electronic and electric device of the embodiment may further include Pin a range of 0.001 mass % or more and 0.1 mass % or less, and S in a range of 0.1 mass % or more and 2.0 mass % or less.

In the copper alloy for an electronic and electric device of the embodiment, in a case where dσₜ/dεₜ (work-hardening rate) defined by true stress σₜ and true strain εₜ is set as a vertical axis and the true strain εₜ is set as a horizontal axis in a tensile test performed until the fracture of the material, a strained region having a positive slope (d(dσₜ/dεₜ)/dεₜ) of the dσₜ/dεₜ is obtained.

In the embodiment, the rise amount of dσₜ/dεₜ is 30 MPa or more.

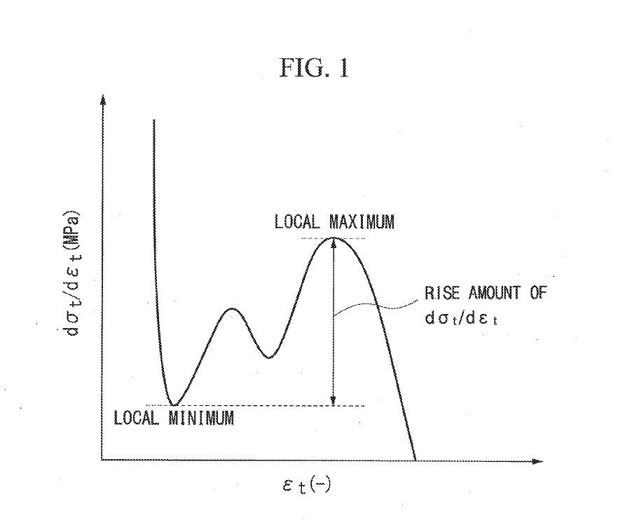

Here, a relationship between the dσₜ/dεₜ (work-hardening rate) and the εₜ (true strain) will be described with reference to FIG. 1.

In the copper alloy for an electronic and electric device of the embodiment, as shown in FIG. 1, the dσₜ/dεₜ increases after a plastic process. As shown in FIG. 1, the dσₜ/dεₜ may move vertically after the increase, but a region of an increase of the dσₜ/dεₜ may be provided, after plastic deformation. In addition, as shown in FIG. 1, the rise amount of dσₜ/dεₜ is defined as a difference between a local minimum and a local maximum of the dεₜ/dεₜ.

The local minimum of the dσₜ/dεₜ described here is a region of the true strain εₜ smaller than the local maximum and a point at which the gradient changes from a negative value to a positive value, on the graph. In a case where a plurality of local minimums are obtained, a value of a local minimum having the lowest dσₜ/dεₜ is used in the calculation of the rise amount of dσₜ/dεₜ, among those.

The local maximum of the dσₜ/dεₜ described here is a point at which the gradient changes from a positive value to a negative value, on the graph. In a case where a plurality of local maximums are obtained, a value of a local maximum having the highest dσₜ/dεₜ is used in the calculation of the rise amount of dσₜ/dεₜ, among those.

In the copper alloy for an electronic and electric device of the embodiment, 0.2% yield strength after finish heat treatment is 400 MPa or more, and conductivity is equal to or greater than 15% IACS. A semi-softening temperature in a case of performing heat treatment for 1 hour at each temperature, based on JCBA T315: 2002 “Test for Annealing Softening Properties of Copper and Copper Alloy Sheet Strip” is equal to or higher than 300° C.

Here, reasons of regulating the component composition and the dσₜ/dεₜ as described above will be described below.

(Mg: 0.5 Mass % to 3.0 Mass %)

Mg is an element having an effect of improving the 0.2% yield strength.

Here, in a case where the content of Mg is less than 0.5 mass %, the effect thereof may not be sufficiently exhibited. On the other hand, in a case where the content of Mg exceeds 3.0 mass %, intermetallic compounds having Cu and Mg as main components may remain in a heat solution treatment, and thus, cracks may occur in the subsequent rolling process.

Therefore, in the embodiment, the content of Mg is set to be in a range of 0.5 mass % to 3.0 mass %.

In order to reliably improve the 0.2% yield strength, the lower limit of the content of Mg is preferably equal to or greater than 0.55 mass % and more preferably equal to or greater than 0.6 mass %. In addition, in order to further improve rolling process properties, the upper limit of the content of Mg is preferably equal to or less than 2.8 mass % and more preferably equal to or less than 2.5 mass %.

(P: 0.001 Mass % to 0.1 Mass %)

P has an effect of improving castability, and thus, P may be suitably added according to the purpose of use.

Here, in a case where the content of P is less than 0.001 mass %, the effect thereof may not be sufficiently exhibited. On the other hand, in a case where the content of P exceeds 0.1 mass %, conductivity may significantly decrease.

Therefore, in a case of adding P in the embodiment, the content of P is set to be in a range of 0.001 mass % to 0.1 mass %. In order to reliably improve castability, the lower limit of the content of P is preferably equal to or greater than 0.002 mass % and more preferably equal to or greater than 0.003 mass %. In addition, in order to reliably prevent a decrease in conductivity, the upper limit of the content of P is preferably equal to or less than 0.09 mass % and more preferably equal to or less than 0.08 mass %.

(Sn: 0.1 Mass % to 2.0 Mass %)

Sn has an effect of further improving the 0.2% yield strength and heat resistance, and thus, Sn may be suitably added according to the purpose of use.

Here, in a case where the content of Sn is less than 0.1 mass %, the effect thereof may not be sufficiently exhibited. On the other hand, in a case where the content of Sn exceeds 2.0 mass %, conductivity may significantly decrease.

Therefore, in a case of adding Sn in the embodiment, the content of Sn is set to be in a range of 0.1 mass % to 2.0 mass %. In order to reliably improve 0.2% yield strength and heat resistance, the lower limit of the content of Sn is preferably equal to or greater than 0.12 mass % and more preferably equal to or greater than 0.15 mass %. In addition, in order to reliably prevent a decrease in conductivity, the upper limit of the content of Sn is preferably equal to or less than 1.8 mass % and more preferably equal to or less than 1.6 mass %.

(Inevitable Impurities: 0.1 Mass % or Less)

Examples of the inevitable impurities include B, Cr, Ti, Fe, Co, O, S, C, (P), Ag, (Sn), Al, Zn, Ca, Te, Mn, Sr, Ba, Sc, Y, Hf, V, Nb, Ta, Mo, W, Re, Ru, Os, Se, Rh, Ir, Pd, Pt, Au, Cd, Ga, In, Li, Ge, As, Sb, Tl, Pb, Be, N, H, Hg, Tc, Na, K, Rb, Cs, Po, Bi, lanthanoid, Ni, Si, and Zr. These inevitable impurities have an effect of decreasing conductivity, and thus, a small amount thereof is desirable. Even in a case where a scrap is used as a raw material, the total amount thereof is preferably equal to or less than 0.1 mass %, more preferably equal to or less than (0.09) mass %, and even more preferably equal to or less than (0.08) mass %.

The upper limit value of each element is desirably equal to or less than 200 mass ppm, more preferably equal to or less than 100 mass ppm, even more preferably equal to or less than 50 mass ppm.

(dσₜ/dεₜ)

Normally, in a case of performing a tensile test for a typical copper alloy until the fracture of the material, the dσₜ/dεₜ steadily decreases. With respect to this, in the copper alloy for an electronic and electric device of the embodiment, a region of an increase in dσₜ/dεₜ is provided after a plastic process, as shown in FIG. 1. In order to obtain such a configuration, it is necessary to perform the finish heat treatment under conditions of a higher temperature and a longer period of time than usual, in a state where a grain size and uniformity thereof are controlled, as will be described later.

In a case where the finish heat treatment is performed under conditions of a higher temperature and a longer period of time than usual, in a state where the grain size and uniformity thereof are controlled, a dislocation structure in the material changes to a stable dislocation structure. In a case where plastic deformation is added to the stable dislocation structure, the dσₜ/dεₜ temporarily decreases, in accordance with the start of the plastic deformation. After the decrease in dσₜ/dεₜ, an interaction between dislocations becomes stronger than usual, and thus, the dσₜ/dεₜ increases.

Here, by setting the rise amount of dσₜ/dεₜ to be equal to or greater than 30 MPa, uniform elongation is further improved and excellent bendability can be obtained. In order to further improve uniform elongation, the rise amount of dσₜ/dεₜ is preferably equal to or greater than 50 MPa, more preferably equal to or greater than 100 MPa, even more preferably equal to or greater than 200 MPa, and particularly preferably equal to or greater than 300 MPa.

(0.2% Yield Strength after Finish Heat Treatment: Equal to or Greater than 400 MPa)

The copper alloy for an electronic and electric device of the embodiment is particularly suitable as a raw material of the component for an electronic and electric device such as a terminal such as a connector or a press fit, a relay, a lead frame, or a bus bar, by setting the 0.2% yield strength after finish heat treatment to be equal to or greater than 400 MPa. In the embodiment, the 0.2% yield strength after finish heat treatment in a case of the tensile test is performed in a direction perpendicular to a rolling direction, is set to be equal to or greater than 400 MPa.

Here, the 0.2% yield strength is preferably equal to or greater than 425 MPa and more preferably equal to or greater than 450 MPa.

(Conductivity: Equal to or Greater than 15% IACS)

The copper alloy for an electronic and electric device of the embodiment can be used as the component for an electronic and electric device such as a terminal such as a connector or a press fit, a relay, a lead frame, or a bus bar, in an excellent manner, by setting the conductivity to be equal to or greater than 15% IACS.

The conductivity is preferably equal to or greater than 20% IACS and more preferably equal to or greater than 30% IACS.

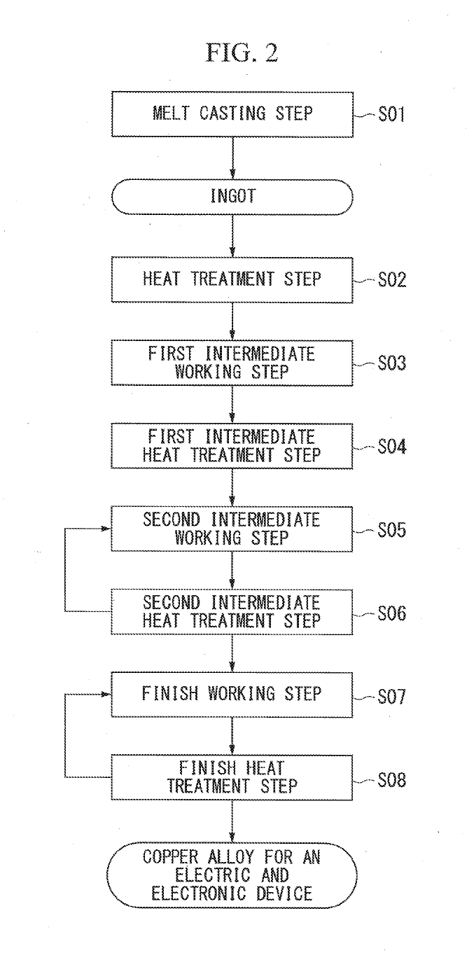

Next, a manufacturing method of the copper alloy for an electronic and electric device of the embodiment having such a configuration will be described with reference to a flowchart shown in FIG. 2.

(Melting and Casting Step S01)

First, component adjustment is performed by adding the elements described above into molten copper obtained by melting a copper raw material, and a molten copper alloy is produced. For the addition of various elements, a simple element or a base alloy can be used. The raw material including the element described above may be melted with the copper raw material. In addition, a recycled material and a scrap material of the alloy may be used. Here, as the molten copper, so-called 4NCu having a purity of equal to or greater than 99.99 mass % is preferably used. The additive element having a purity of equal to or greater than 99.9 mass % is preferably used. In the melting, an atmosphere furnace may be used, and in order to prevent oxidation of the additive element, a vacuum furnace, or an atmosphere furnace set to have an inert gas atmosphere or reducing atmosphere may be used.

The molten copper alloy subjected to the component adjustment is injected to a die and an ingot is produced. In a case where productivity is considered, a continuous casting method or a semi-continuous casting method is preferably used.

(Heat Treatment Step S02)

Next, heat treatment is performed for homogenization and solutionizing of the obtained ingot. By heating the ingot, the additive elements are homogenously diffused or the additive elements are solid-solutionized in a matrix, in the ingot.

Here, in the heat treatment step S02, a heat treatment method is not particularly limited, and the heat treatment is preferably performed in a non-oxidizing atmosphere or a reducing atmosphere at a holding temperature of 400° C. to 900° C. and a holding time of 1 hour to 10 hours, in order to prevent generation of precipitates. In addition, a cooling method performed after the heating is not particularly limited, and a method such as water quenching performed by setting a cooling rate to be equal to or higher than 200° C./min is preferably used.

Further, a hot working process may be performed after the heat treatment, for the efficiency of rough processing and uniformity of structures. A process method is not particularly limited, and rolling, line drawing, extruding, groove rolling, forging, or pressing can be used. In a case where a final shape is a plate or a strip, the rolling is preferably used. In addition, a temperature at the time of the hot working process is not particularly limited, either, and is preferably set to be in a range of 400° C. to 900° C.

(First Intermediate Working Step S03)

Next, the material after the heat treatment step S02 is cut, if necessary, and surface grinding is performed, if necessary, for removing oxide scale or the like. After that, a plastic process is performed to obtain a predetermined shape.

A temperature condition in the first intermediate working step S03 is not particularly limited, and is preferably set to be in a range of −200° C. to 200° C. for cold working or hot working process. A processing rate is suitably selected so as to obtain the approximate final shape, and is preferably equal to or greater than 30%, more preferably equal to or greater than 35%, and even more preferably equal to or greater than 40%. A plastic processing method is not particularly limited, and rolling, line drawing, extruding, groove rolling, forging, or pressing can be used.

(First Intermediate Heat Treatment Step S04)

After the first intermediate working step S03, the heat treatment is performed for the toughness of solutionizing, recrystallization structure, and improvement of workability.

The method of the heat treatment is not particularly limited, and the heat treatment is preferably performed in a non-oxidizing atmosphere or a reducing atmosphere at the holding temperature of 400° C. to 900° C. for the holding time of 10 seconds to 10 hours. In addition, a cooling method performed after the heating is not particularly limited, and a method performed by setting a cooling rate such as water quenching to be equal to or higher than 200° C./min is preferably used.

(Second Intermediate Working Step S05)

The surface grinding is performed, if necessary, for removing oxide scale generated in the first intermediate heat treatment step S04. Then, the plastic process is performed to obtain a predetermined shape.

A temperature condition in the second intermediate working step S05 is not particularly limited, and is preferably set to be in a range of −200° C. to 200° C. for cold working or hot working process. A processing rate is suitably selected so as to obtain the approximate final shape, and is preferably equal to or greater than 20% and more preferably equal to or greater than 30%. A plastic processing method is not particularly limited, and rolling, line drawing, extruding, groove rolling, forging, or pressing can be used.

(Second Intermediate Heat Treatment Step S06)

After the second intermediate working step S05, the heat treatment is performed for toughness of solutionizing, recrystallization structure, and improvement of workability. The method of the heat treatment is not particularly limited, and the heat treatment is preferably performed in a non-oxidizing atmosphere or a reducing atmosphere at the holding temperature of 400° C. to 900° C. for the holding time of 10 seconds to 10 hours. In addition, a cooling method performed after the heating is not particularly limited, and a method performed by setting a cooling rate such as water quenching to be equal to or higher than 200° C./min is preferably used.

In the embodiment, before performing a finish working step S07 and a finish heat treatment step S08 which will be described later, the second intermediate working step S05 and the second intermediate heat treatment step S06 described above are performed repeatedly for a necessary number of times, in order to prevent the grain size and uniformity thereof.

Specifically, the second intermediate working step S05 and the second intermediate heat treatment step S06 described above are repeatedly performed, until an average grain size d becomes equal to or greater than 1 μm and a standard deviation of the grain size becomes equal to or smaller than the average grain size d.

Here, by setting the average grain size to be equal to or greater than 1 μm before the finish working step S07, it is possible to increase a softening temperature in the finish heat treatment step S08, set the heat treatment conditions to a high temperature for a long period of time, and improve uniform elongation. The average grain size before the finish working step S07 is preferably 5 μm to 80 μm and more preferably 8 μm to 20 μm.

In a case where the standard deviation of the grain size is set to be equal to or smaller than the average grain size d before the finish working step S07, strain can be uniformly applied in the finish working step S07. Accordingly, it is possible to uniformly increase strength of interaction between dislocations in the material, and to reliably increase the dσₜ/dεₜ. The standard deviation of the grain size before the finish working step S07 is desirably equal to or smaller than 2d/3, in a case where the average grain size d is equal to or smaller than 80 μm. The standard deviation thereof is more desirably equal to or smaller than d/2.

(Finish Working Step S07)

The finish process is performed with respect to the copper raw material after the second intermediate heat treatment step S06 to obtain a predetermined shape. A temperature condition in the finish working step S07 is not particularly limited, and is preferably set to be in a range of −200° C. to 200° C. for cold working or hot working process.

By setting a processing rate (rolling rate) in the finish working step S07 to be equal to or greater than 50%, it is possible to improve the 0.2% yield strength. In order to further improve the 0.2% yield strength, the processing rate (rolling rate) is more preferably equal to or greater than 55% and even more preferably equal to or greater than 60%.

(Finish Heat Treatment Step S08)

Next, the finish heat treatment is performed with respect to the copper raw material obtained by the finish working step S07. A finish heat treatment temperature is preferably set as a temperature equal to or higher than 300° C., in a case where the finish heat treatment temperature is, for example, 300° C., the holding time is preferably equal to or longer than 1 minute, and in a case where the finish heat treatment temperature is 500° C., the holding time is preferably set to be equal to or longer than 5 seconds. In addition, the finish heat treatment is preferably performed in a non-oxidizing atmosphere or a reducing atmosphere.

In addition, a cooling method performed after the heating is not particularly limited, and a method such as water quenching performed by setting a cooling rate to be equal to or higher than 60° C./min is preferably used.

The finish working step S07 and the finish heat treatment step S08 described above may be repeatedly performed several times.

By doing so, the copper alloy for an electronic and electric device and a plastically-worked material of the copper alloy for an electronic and electric device are produced. The plastically-worked material of the copper alloy for an electronic and electric device may be used in the component for an electronic and electric device as it is, and may be Sn-plated on one surface or both surfaces of a sheet to have a film thickness of approximately 0.1 to 10 μm, as a plated copper alloy member.

In addition, by performing a punching process or a bending process with respect to the copper alloy for an electronic and electric device of the embodiment (plastically-worked material of the copper alloy for an electronic and electric device), the component for an electronic and electric device such as a terminal such as a connector or a press fit, a relay, a lead frame, or a bus bar is formed, for example.

According to the copper alloy for an electronic and electric device of the embodiment having the configuration described above, in a case where the dσₜ/dεₜ (work-hardening rate) defined by the true stress σₜ and the true strain εₜ is set as a vertical axis and the true strain εₜ is set as a horizontal axis in the tensile test, the strained region having a positive slope of the dσₜ/dεₜ is obtained, the dσₜ/dεₜ increases, after plastic deformation, and thus, the uniform elongation is improved and particularly excellent bendability is obtained.

Particularly, in the embodiment, the rise amount of dσₜ/dεₜ is set to be equal to or greater than 30 MPa, the uniform elongation can be reliably improved and bendability can be further improved.

In the embodiment, 0.5 mass % to 3.0 mass % of Mg is included, and accordingly, it is possible to obtain high 0.2% yield strength.

In the embodiment, in a case of including P in a range of 0.001 mass % or more and 0.1 mass % or less, it is possible to improve castability without significantly decreasing conductivity.

In the embodiment, in a case of including S in a range of 0.1 mass % or more and 2.0 mass % or less, it is possible to further improve heat resistance without significantly decreasing conductivity.

In the copper alloy for an electronic and electric device of the embodiment, the 0.2% yield strength in a case where the tensile test is performed in a direction perpendicular to the rolling direction is 400 MPa or more and the conductivity is set to be equal to or greater than 15% IACS. Accordingly, copper alloy for an electronic and electric device is particularly suitable as the material of the component for an electronic and electric device such as a terminal such as a connector or a press fit, a relay, a lead frame, or a bus bar.

In addition, in the copper alloy for an electronic and electric device of the embodiment, the semi-softening temperature in a case of performing the heat treatment for 1 hour at each temperature, based on JCBA T315: 2002 “Test for Annealing Softening Properties of Copper and Copper Alloy Sheet Strip” is equal to or higher than 300° C. Thus, it is possible to prevent a decrease in 0.2% yield strength in the finish heat treatment step S08.

The plastically-worked material of the copper alloy for an electronic and electric device is of the embodiment configured with the copper alloy for an electronic and electric device. Thus, by performing the bending process with respect to the plastically-worked material of the copper alloy for an electronic and electric device, it is possible to manufacture the component for an electronic and electric device such as a terminal such as a connector or a press fit, a relay, a lead frame, or a bus bar.

The plastically-worked material of the copper alloy for an electronic and electric device having the Sn-plated surface can be used as materials of various components for an electronic and electric device.

In addition, the component for an electronic and electric device of the embodiment (a terminal such as a connector or a press fit, a relay, a lead frame, or a bus bar) is configured with the copper alloy for an electronic and electric device, and thus, excellent reliability is obtained.

Hereinabove, the copper alloy for an electronic and electric device, the plastically-worked material of the copper alloy for an electronic and electric device, the component for an electronic and electric device, the terminal, and the bus bar of the embodiment of the present invention have been described, but the present invention is not limited thereto, and suitable changes can be performed within a range not departing from the technical ideas of the present invention.

For example, in the embodiment described above, one example of the manufacturing method of the copper alloy for an electronic and electric device has been described, but the manufacturing method of the copper alloy for an electronic and electric device is not limited to the method described in the embodiment, and a well-known manufacturing method may be suitably selected for the manufacturing.

### Examples

Hereinafter, results of a confirmation test performed for confirming the effects of the present invention will be described.

A raw material made of oxygen-free copper having purity equal to or greater than 99.99 mass % (ASTM B152 C10100) was prepared, and this was inserted into a high-purity graphite crucible and melted with a high frequency in an atmosphere furnace set as an Ar gas atmosphere. Various additive elements were added into the obtained molten copper to prepare a component composition shown in Table 1, and this was poured into a carbon mold to produce an ingot. A size of the ingot was set so as to have a thickness of approximately 80 mm, a width of approximately 150 mm, and a length of approximately 70 mm.

The vicinity of the casting surface of the ingot was surface-grinded, and the ingot was cut out to adjust the size thereof so that a sheet thickness of a final product becomes 0.5 mm, 1.0 mm, and 2.0 mm.

In order to perform homogenization and solutionizing with respect to the obtained ingot, the heat treatment step was performed at the holding temperature and the holding time shown in Table 1 in the Ar gas atmosphere, and after that, water quenching was performed.

The material after the heat treatment was cut, and the surface grinding was performed for removing oxide scale.

Next, after performing cold rolling at a rolling rate shown in Table 1 as the first intermediate working step, the heat treatment was performed at the temperature and the holding time shown in Table 1 by using a salt bath as the first intermediate heat treatment. In Table 1, the first intermediate working step was shown as “intermediate rolling 1” and the first intermediate heat treatment step was shown as “intermediate heat process 1”.

Then, after performing cold rolling at the rolling rate shown in Table 1 as the second intermediate working step, the heat treatment was performed at the temperature and the holding time shown in Table 1 by using a salt bath as the second intermediate heat treatment. In Table 1, the first-second intermediate working step was shown as “intermediate rolling 2” and the first-second intermediate heat treatment step was shown as “intermediate heat process 2”.

In addition, after performing cold rolling at the rolling rate shown in Table 1 as the second-second intermediate working step, the heat treatment was performed at the temperature and the holding time shown in Table 1 by using a salt bath as the second-second intermediate heat treatment. In Table 1, the second-second intermediate working step was shown as “intermediate rolling 3” and the second-second intermediate heat treatment step was shown as “intermediate heat process 3”.

The grain size before the finish working step was measured. A sample was collected from the material subjected to the second-second intermediate heat treatment step, a section perpendicular to the rolling direction was observed, and the average value of the grain size and the standard deviation were measured. After performing mechanical polishing by using waterproof abrasive paper and diamond abrasive grains, the finish polishing was performed by using a colloidal silica solution. Misorientation of each grain was analyzed at an acceleration voltage of an electron ray of 20 kV, at a step of a measurement interval of 0.1 μm, and in a measurement area of 1,000 μm², with EBSD measurement devices (Quanta FEG 450 manufactured by Thermo Fisher Scientific, and OIM Data Collection manufactured by EDAX/TSL (currently, AMETEK Inc.)) and analysis software (OIM Data Analysis ver. 5.3 manufactured by EDAX/TSL (currently, AMETEK Inc.)). A CI value of each measurement point was calculated by the analysis software OIM, and the CI value equal to or smaller than 0.1 was removed from the analysis of the grain size. Regarding a grain boundary, as a result of observation of a two-dimensional section, a map of the grain boundary was drawn by using a point removing twin crystal from the measurement point at which disorientation of the orientation between two adjacent crystals becomes equal to or greater than 15°, as the grain boundary. In a measurement method of the grain size, an average value of a long diameter (a length of the longest straight line drawn in the grain under the condition of not being in contact with the grain boundary in the middle) and a short diameter (a length of the longest straight line drawn in the grain in a direction perpendicular to the long diameter under the condition of not being in contact with the grain boundary in the middle) of the grain was set as the grain size. With this method, the measurement regarding 200 grains was performed with respect to each sample, and the average value and the standard deviation of the grain size were calculated. Results are shown in Table 2.

Next, the finish rolling was performed with respect to the material subjected to the second-second intermediate heat treatment step at the rolling rate shown in Table 2, and a rolled sheet having a sheet thickness (thickness of 0.5 mm, 1.0 mm, or 2.0 mm) shown in Table 2, a width of 150 mm, and a length equal to or greater than 200 mm was manufactured.

Then, the finish heat treatment was performed at the temperature and the holding time shown in Table 2 in the Ar gas atmosphere, and a strip material for property evaluation was manufactured.

(Evaluation of Mechanical Properties)

A test piece No. 13B regulated in JIS Z 2201 was collected from the material before the finish heat treatment and the strip material for property evaluation after the finish heat treatment, and the 0.2% yield strength was measured by an offset method of JIS Z 2241. In this case, a strain rate was set as 0.7 mm/s, and data of a testing force and displacement of the test piece was collected for every 0.01 s. The test piece was collected so that a tensile direction of the tensile test is perpendicular to the rolling direction of the strip material for property evaluation. Results are shown in Table 2.

From the results of the tensile test of the strip material for property evaluation, the true stress σₜ and the true strain εₜ were evaluated. A load was set as F, a test piece initial sectional area was set as S₀, an initial parallel portion length was set as L₀, and elongation from the initial stage in the test was set as ΔL. A value obtained by dividing the load F by the test piece initial sectional area S₀ is set as nomiral stress σₙ and a value obtained by dividing the elongation ΔL by the initial parallel portion length L₀ is set as nomiral strain εₙ.

With respect to this, stress obtained by considering the sectional area of the test piece during the deformation was set as the true stress εₜ, strain obtained by considering the parallel portion length during the deformation was set as the true strain εₜ, and calculation was performed according to the following equations.

σₜ=σₙ(1+εₙ)

εₜ=ln(1+εₙ)

(dσₜ/dεₜ)

The dσₜ/dεₜ was calculated from the data of the true stress σₜ and the true strain εₜ obtained as described above, and a graph shown in FIG. 1 was drawn by setting the εₜ as a horizontal axis and the dσₜ/dεₜ as a vertical axis. Here, the displacement amount of the true strain εₜ for each 0.01 s was defined as dεₜ and a change in true stress σₜ for each 0.01 s was set as dσₜ. A graph having a region of an increase in dσₜ/dεₜ was evaluated as “A”, and a graph not having the region was evaluated as “B”. Evaluation results are shown in Table 2.

In addition, the gradient of the dσₜ/dεₜ was acquired, the largest value among values of the dσₜ/dεₜ, in a case where the gradient becomes 0 from a positive value, was acquired as the local maximum. Further, the smallest value among values of the dσₜ/dεₜ, in a region of the true strain εₜ smaller than the local maximum, in a case where the gradient becomes 0 from a negative value, was acquired as the local minimum. A difference between the local maximum and the local minimum was set as the rise amount of dσₜ/dεₜ. Evaluation results are shown in Table 2.

(Conductivity)

A test piece having a width of 10 mm and a length of 150 mm was collected from the strip material for property evaluation, and electric resistance was acquired by a four-terminal method. In addition, dimension measurement of the test piece was performed by using a micrometer and a volume of the test piece was calculated. Then, the conductivity was calculated from the measured electric resistance value and volume. The test piece was collected so that a longitudinal direction thereof is parallel to the rolling direction of the strip material for property evaluation. Evaluation results are shown in Table 2.

(Bendability)

The bending process was performed based on the four-test method of technical standard JCBA-T307: 2007 of Japan Copper and Brass Association.

A plurality of test pieces having a width of 10 mm and a length of 30 mm were collected from the strip material for property evaluation so that a bending axis is parallel to the rolling direction, and a W bending test was performed by using a W-shaped jig in which a bending angle was set as 90 degrees and a bending radius was twice the thickness of each sheet thickness. A case where cracks were visually confirmed was evaluated as “B” and a case where cracks were not observed was evaluated as “A”. Evaluation results are shown in Table 2.

TABLE 1

| | | | | | | | | Inter- | Intermediate | | Inter- | Intermediate | | Inter- | Intermediate | |
|---|---|---|---|---|---|---|---|---|---|---|---|---|---|---|---|---|
| | | | | | | Heat | | mediate | heat | | mediate | heat | | mediate | heat | |
| | | | | | | treatment | | rolling 1 | treatment 1 | | rolling 2 | treatment 2 | | rolling 3 | treatment 3 | |
| | | Mg | P | Sn | | Temper- | | Rolling | Temper- | | Rolling | Temper- | | Rolling | Temper- | |
| | | mass | mass | mass | | ature | Time | rate | ature | Time | rate | ature | Time | rate | ature | Time |
| | | % | % | % | Cu | ° C. | h | % | ° C. | min | % | ° C. | min | % | ° C. | min |
| Invention | 1 | 0.51 | — | — | Balance | 850 | 4 | 70 | 750 | 30 | 60 | 650 | 30 | 60 | 600 | 1 |
| Example | 2 | 0.53 | 0.002 | — | Balance | 850 | 4 | 60 | 750 | 60 | 60 | 700 | 30 | 50 | 650 | 1 |
| | 3 | 0.58 | — | — | Balance | 850 | 4 | 60 | 750 | 30 | 60 | 650 | 30 | 60 | 580 | 1 |
| | 4 | 0.56 | — | 0.10 | Balance | 850 | 4 | 60 | 650 | 60 | 70 | 650 | 30 | 70 | 600 | 1 |
| | 5 | 0.61 | — | — | Balance | 850 | 4 | 70 | 650 | 60 | 70 | 650 | 60 | 70 | 620 | 1 |
| | 6 | 0.70 | 0.003 | — | Balance | 850 | 4 | 70 | 750 | 60 | 80 | 650 | 60 | 80 | 600 | 5 |
| | 7 | 1.15 | — | — | Balance | 850 | 4 | 60 | 750 | 90 | 70 | 650 | 60 | 70 | 610 | 1 |
| | 8 | 1.35 | 0.002 | 0.25 | Balance | 850 | 4 | 60 | 750 | 60 | 70 | 700 | 60 | 70 | 620 | 1 |
| | 9 | 1.55 | — | — | Balance | 850 | 4 | 70 | 700 | 60 | 80 | 700 | 30 | 80 | 600 | 1 |
| | 10 | 1.60 | 0.004 | — | Balance | 850 | 4 | 60 | 750 | 30 | 60 | 700 | 30 | 60 | 600 | 2 |
| | 11 | 1.65 | — | — | Balance | 850 | 4 | 50 | 750 | 60 | 70 | 750 | 60 | 70 | 650 | 1 |
| | 12 | 1.81 | — | — | Balance | 850 | 4 | 50 | 750 | 60 | 70 | 750 | 60 | 70 | 625 | 1 |
| | 13 | 2.24 | — | — | Balance | 850 | 4 | 80 | 800 | 60 | 70 | 750 | 60 | 70 | 650 | 1 |
| | 14 | 2.98 | 0.002 | 0.10 | Balance | 850 | 4 | 80 | 800 | 60 | 70 | 750 | 60 | 70 | 700 | 1 |
| | 15 | 0.61 | 0.090 | — | Balance | 850 | 4 | 60 | 750 | 60 | 50 | 700 | 60 | 50 | 650 | 1 |
| | 16 | 0.89 | — | 1.90 | Balance | 850 | 4 | 80 | 750 | 60 | 50 | 700 | 60 | 50 | 600 | 2 |
| | 17 | 2.99 | 0.100 | 1.99 | Balance | 850 | 4 | 80 | 800 | 60 | 70 | 750 | 60 | 70 | 720 | 1 |
| Comparative | 1 | 0.09 | — | — | Balance | 850 | 4 | 50 | 750 | 30 | 60 | 650 | 30 | 60 | 700 | 1 |
| Example | 2 | — | 0.340 | 6.10 | Balance | 750 | 4 | 40 | 750 | 60 | 50 | 650 | 30 | 50 | 600 | 30 |
| | 3 | 3.51 | — | — | Balance | 850 | 8 | 50 | 750 | 30 | 60 | 650 | 30 | — | — | — |
| | 4 | 1.56 | — | — | Balance | 850 | 4 | 95 | 590 | 5 | — | — | — | — | — | — |

TABLE 2

| | | | | | | | | 0.2% Yield | | | dσₜ/dϵₜ | | |
|---|---|---|---|---|---|---|---|---|---|---|---|---|---|
| | | Grain size | | Finish | Finish heat | | Final | strength (MPa) | | | Presence or | | |
| | | before finish | | rolling | treatment | | sheet | Before | After | | absence of | | |
| | | rolling (μm) | | Rolling | Temper- | | thick- | finish | finish | Conduc- | region having | Amount | Bend- |
| | | | Standard | rate | ature | Time | ness | heat | heat | tivity | positive | increased | ability |
| | | Average | deviation | % | ° C. | min | mm | treatment | treatment | % IACS | slope | MPa | BW |
| Invention | 1 | 8.2 | 3.9 | 60 | 300 | 5 | 1.0 | 512 | 481 | 69.1 | A | 39 | A |
| Example | 2 | 18.1 | 6.3 | 70 | 450 | 10 | 2.0 | 461 | 401 | 67.6 | A | 425 | A |
| | 3 | 5.2 | 2.5 | 90 | 400 | 90 | 0.5 | 482 | 427 | 66.3 | A | 354 | A |
| | 4 | 8.2 | 3.9 | 75 | 400 | 5 | 1.0 | 546 | 489 | 63.3 | A | 220 | A |
| | 5 | 11.7 | 5.0 | 75 | 300 | 300 | 0.5 | 573 | 521 | 65.1 | A | 106 | A |
| | 6 | 8.3 | 3.9 | 80 | 350 | 40 | 0.5 | 551 | 506 | 61 | A | 333 | A |
| | 7 | 9.9 | 4.5 | 70 | 400 | 10 | 1.0 | 588 | 561 | 49.7 | A | 152 | A |
| | 8 | 11.7 | 5.0 | 75 | 350 | 60 | 0.5 | 699 | 676 | 41.3 | A | 200 | A |
| | 9 | 8.2 | 3.9 | 85 | 300 | 10 | 0.5 | 760 | 740 | 42.3 | A | 64 | A |
| | 10 | 8.2 | 3.9 | 80 | 300 | 600 | 1.0 | 716 | 696 | 41.1 | A | 483 | A |
| | 11 | 18.1 | 6.3 | 80 | 325 | 180 | 1.0 | 707 | 688 | 40.8 | A | 538 | A |
| | 12 | 9.1 | 4.2 | 80 | 350 | 60 | 0.5 | 737 | 720 | 38.7 | A | 181 | A |
| | 13 | 27.0 | 7.5 | 70 | 350 | 60 | 1.0 | 569 | 556 | 33.9 | A | 478 | A |
| | 14 | 62.9 | 10.0 | 60 | 350 | 60 | 1.0 | 831 | 820 | 27.3 | A | 327 | A |
| | 15 | 18.1 | 6.3 | 60 | 350 | 60 | 2.0 | 519 | 468 | 67 | A | 315 | A |
| | 16 | 8.2 | 3.9 | 50 | 325 | 90 | 2.0 | 566 | 530 | 31 | A | 123 | A |
| | 17 | 77.2 | 10.6 | 60 | 400 | 60 | 0.5 | 850 | 840 | 16.6 | A | 336 | A |
| Comparative | 1 | 73.0 | 10.5 | 45 | 375 | 60 | 0.5 | 378 | 241 | 83 | A | 20 | A |
| Example | 2 | 35.0 | 8.9 | 90 | 400 | 5 | 0.5 | 780 | 391 | 16 | A | 154 | A |
| | 3 | — | — | — | — | — | — | — | — | — | — | — | — |
| | 4 | 10.5 | 12.5 | 85 | 250 | 300 | 2.0 | 721 | 703 | 42 | B | — | B |

In Comparative Example 1, the content of Mg was less than the range of the present invention and the 0.2% yield strength was low.

In Comparative Example 2, although phosphor bronze was obtained, the heat resistance was not sufficient. Thus, the 0.2% yield strength after the finish heat treatment significantly decreased.

In Comparative Example 3, the content of Mg was greater than the range of the present invention and the cracks were generated during the manufacturing. Thus, the evaluation was stopped.

In Comparative Example 4, the second intermediate working and the second intermediate heat treatment were not performed, the standard deviation of the grain size before the finish process and the finish heat treatment was greater than the average grain size d, and a region having an increase in dσₜ/dεₜ was not observed. Accordingly, bendability was not sufficient.

On the other hand, in the present invention examples, the average grain size before the finish process and the finish heat treatment was set to be equal to or greater than 1 μm, and the standard deviation of the grain size was set to be equal to or smaller than the average grain size d. After the finish heat treatment, a region having an increase in dσₜ/dεₜ was observed and excellent bendability was obtained.

From the above results, according to the present invention examples, it is confirmed that it is possible to provide a copper alloy for an electronic and electric device and a plastically-worked material of the copper alloy for an electronic and electric device having particularly excellent bendability and high 0.2% yield strength.

### INDUSTRIAL APPLICABILITY

It is possible to provide the copper alloy for an electronic and electric device, the plastically-worked material of the copper alloy for an electronic and electric device, the component for an electronic and electric device, the terminal, and the bus bar having particularly excellent bendability and high conductivity.

### REFERENCE SIGNS LIST

S05: Second Intermediate Working Step

S06: Second Intermediate Heat Treatment Step

S07: Finish Working Step

S08: Finish Heat Treatment Step

1. A copper alloy for an electronic and electric device comprising:
Mg in a range of 0.5 mass % or more and 3.0 mass % or less; and
a Cu balance including inevitable impurities,
wherein, a graph, in which a vertical axis is dσₜ/dεₜ and a horizontal axis is a true strain εₜ, dσₜ/dεₜ being defined by a true stress σₜ and the true strain εₜ, obtained in a tensile test of the copper alloy, has a strained region that has a positive slope of dσₜ/dεₜ.

2. The copper alloy for an electronic and electric device according to claim 1, wherein 0.2% yield strength after finish heat treatment is 400 MPa or more.

3. The copper alloy for an electronic and electric device according to claim 1, wherein a rise amount of dσₜ/dεₜ is 30 MPa or more.

4. The copper alloy for an electronic and electric device according to claim 1, further comprising P in a range of 0.001 mass % or more and 0.1 mass % or less.

5. The copper alloy for an electronic and electric device according to claim 1, further comprising S in a range of 0.1 mass % or more and 2.0 mass % or less.

6. A component for an electronic and electric device made of the copper alloy for an electronic and electric device according to claim 1.

7. A terminal made of the copper alloy for an electronic and electric device according to claim 1.

8. A bus bar made of the copper alloy for an electronic and electric device according to claim 1.
